(19) United States
(12) Patent Application Publication
(10) Pub. No.: US 2021/0101344 A1
(43) Pub. Date: Apr. 8, 2021

(54) ADDITIVE MANUFACTURING SYSTEM

(71) Applicant: HEWLETT-PACKARD DEVELOPMENT COMPANY, L.P., Spring, TX (US)

(72) Inventors: Pol FORNOS MARTINEZ, Sant Cugat del Valles (ES); Ismael FERNANDEZ AYMERICH, Sant Cugat del Valles (ES); Sergio PUIGARDEU ARAMENDIA, Sant Cugat del Valles (ES)

(21) Appl. No.: 16/772,243

(22) PCT Filed: Mar. 27, 2018
(86) PCT No.: PCT/US2018/024457

§ 371 Date: Jun. 12, 2020

(51) Int. Cl. B29C 64/393; B29C 64/153

(52) U.S. Cl. CPC B29C 64/393; B29C 64/165; B29C 64/153

(57) ABSTRACT

Certain examples relate to altering at least one control parameter of a printing process in an additive manufacturing system. In these examples following a change in operative state of at least one energy source at least one control parameter of a printing process is altered. An energy source is a device configured to apply energy to build material to facilitate the solidification of said build material. Control parameters determine the way a printing process is carried out. In some of these examples control parameters may be the irradiance of an energy source or the way in which the energy source moves over the build material to apply energy to the build material.

### BACKGROUND

Some additive manufacturing systems build three-dimensional objects by depositing agents on portions of successive layers of build material and applying energy from at least one energy source to facilitate the solidification of the portions of build material on which agents have been deposited. The application of energy onto the build material is highly controlled. The application of energy for generating three-dimensional objects is dependent on the type of build material which is used in generating the three-dimensional objects and the process of solidification used to generate the three-dimensional objects. Some additive manufacturing systems have more than one energy source and the energy sources may be of different types.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of a general example of an additive manufacturing system;

FIG. 2 is a schematic diagram of a more specific example of an additive manufacturing system;

FIG. 3 is a flow chart showing a method of printing one or more objects according to some examples;

FIG. 4 is a schematic diagram of objects being manufactured in an additive manufacturing system when a change in operative state is detected according to an example.

FIG. 5 is a schematic diagram of a non-transitory computer-readable storage medium according to some examples.

### DETAILED DESCRIPTION

Certain examples described herein address a challenge of building objects using an additive manufacturing system where an operative state of at least one energy source of the additive manufacturing system has changed during a print process. These examples may be used to help reduce wasted material in additive manufacturing systems where a change in a state of operation of an energy source is detected.

Certain examples described herein make use of control parameters for controlling a print process. For example, a control parameter may relate to the number of times an energy source is configured to pass over successive layers of build material for solidification of portions of the layers of build material on which agents are deposited. A control parameter may relate to the speed at which an energy source moves across a plane which is above and substantially parallel to the material to be processed.

Certain examples described herein make use of energy sources to facilitate the solidification of build material in three-dimensional printing processes. For example, an energy source may be a halogen lamp used to fuse a combination of build material and coalescing agent. In other examples, an energy source may be used to cure build material which has solidified following the application of a chemical binder. The energy source may cure the build material by applying heat energy or ultra-violet (UV) light to the combination of build material and chemical binder. Some of these energy sources may have controllable parameters such as irradiance.

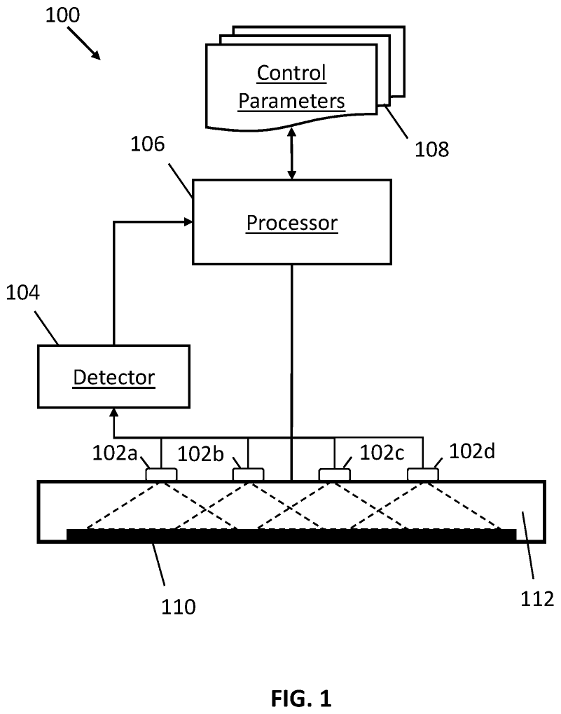

FIG. 1 illustrates an additive manufacturing system 100 for printing one or more objects according to examples. Additive manufacturing may be a type of manufacturing in which three-dimensional objects are built up by the solidification of successive layers of build material. In an example of additive manufacturing a layer of build material may be deposited on to a previous layer of a build material or on to a supporting member 110 if a first layer of build material is not already deposited onto the supporting member 110. Build material may be in the form of powders, liquids, or other types of material suitable for forming an object according to the methods and systems described herein. Portions of the successive layers of build material may be solidified by any of a number of means. In an example, the build material may be solidified through the application of energy from at least one energy source 102a-d to portions of the build material which are to be solidified. In some examples this may include the use of a coalescing agent which is deposited, before or during the application of energy to the build material, onto the portion of the layer of build material which is to be solidified. The suitable application of energy to the combination of build material and coalescing agent may cause the build material on which the coalescing agent is applied to coalesce and solidify. In other examples a binding agent in the form of a liquid may be deposited onto the portion of the layer of the build material which is to be solidified. The nature of the binding agent being such that it chemically solidifies the build material. The chemical solidification may be cured by the application of a suitable amount of energy to the build material. In some examples, the build material may be thermally cured, or cured by the application of UV light.

In some examples more than one agent may be applied to the build material. A first agent may be suitable for facilitating the solidification of the build material by absorbing energy applied from a fusing lamp assembly. A second agent may be suitable for modifying the solidification of the build material. For example, a second agent may decrease the temperature of the build material onto which it is deposited, impeding, or modifying, the solidification of said build material.

The additive manufacturing systems 100 according to the examples of FIG. 1 comprise a plurality of energy sources 102a-d for processing material sequentially in layers. Processing build material may relate to the suitable application of energy to build material for the solidification of said build material. Processing build material may also relate to the full process of solidifying build material including its deposition onto a surface and the application of suitable agents. Energy sources 102a-d present in an additive manufacturing system may be configured to apply infra-red energy, microwave energy, UV light, halogen light, ultra-sonic energy, or other types of energy to the build material. In some examples, at least some of the energy sources 102a-d present in an additive manufacturing system 100 may be configured to apply energy to a build surface in an unfocused manner by emitting energy in a plurality of directions. For example, an energy source 102a may be configured to heat a volume in which a printing process operates without being directed onto build material. In some examples these energy sources 102a-d are positioned at the top of a build chamber 112 either within or externally to the volume of the chamber such that they are able to apply energy to the build chamber 112. In examples where the energy sources 102a-d are positioned externally to the build chamber they may be separated from the volume of the build chamber by glass, acrylic or any suitable material. A build surface may be considered a plane in which successive layers of build material are deposited and solidified. The build chamber 112 may be the volume comprising at least the total of the volume of the one or more objects which are to be built in a printing process.

Some of the energy sources 102a-d may apply energy to the build surface in a focused manner. For example, an energy source 102a-d may be a laser, wherein the energy provided by a focused beam of light from the laser delivers sufficient energy to a build material, or a combination of build material and agents, to cause the build material to solidify, coalesce, or fuse. Focused energy sources 102a-d may be used for solidifying selected portions of a build material. In other examples, energy sources are used to scan over a whole build surface to provide suitable energy to cause the portions of build material in the build surface on which agents are deposited to solidify or fuse. In some examples the energy sources are used to scan over a whole build surface on which a chemical binding agent has been applied to cure or harden the solidified build material.

In some cases, the operative state of an energy source 102a-d may change during a print process resulting in the processing of build material being potentially compromised.

In the examples of FIG. 1, the additive manufacturing system 100 comprises a detector 104 to detect a change in operative state of at least one of the energy sources 102a-d during a printing process. The detector 104 may be configured to generate data indicative of the change in operative state of the at least one energy source 102a-d during the printing process. In some examples the data indicative of a change in operative state comprises information indicative of from which energy source 102a-d the change in operative state is detected. The detector 104 may be configured to determine specific information about the change in operative state of the at least one energy source during a printing process. For example, in examples where the at least one energy source 102a-d which changes operative state is a lamp, the detector 104 may be able to determine if the change in operative state is a burnout of the lamp. In other examples, the detector 104 may be able to detect if the connection to the energy source 102a-d is broken. The detector 104 may be implemented as a current sensor which detects the operating current of an energy source 102a-d. In some examples the detector 104 is a combination of hardware and programing code configured to detect a change in current of an energy source and generate data indicative of a change in operative state of that energy source. The detector 104 may measure the temperature of each energy source 102a-d to determine whether there is a change in power output from the energy source. The detector 104 may be implemented as individual sensors monitoring the operative state of each of the energy sources. In other examples the detector 104 may be a device which is configured to detect generic information about the change in operative state in any of the energy sources 102a-d. The detector 104 may be implemented as an application specific integrated circuit connected to the energy sources within the additive manufacturing system. In examples according to FIG. 1, the detector 104 is positioned locally with the energy sources 102a-d of the additive manufacturing system. However, in other examples, the detector 104 may be located remotely from the energy sources and may be configured to receive data relating to the operation of the energy sources 102a-d from which it may determine or detect a change in operative state in at least one of the energy sources 102a-d.

A change in operative state of an energy source 102a-d may relate to any change in the state of the energy source 102a-d which results in the application of energy to the build material to change. Some examples may include; a burnout of a lamp, a compromised electrical connection to an energy source, a reduction in irradiance of an energy source 102a-d, or an uncontrolled increase in irradiance of an energy source due to a compromised circuit, connection, or control system.

In the examples of FIG. 1 the additive manufacturing system 100 comprises a processor 106 which is configured to begin a printing process using the additive manufacturing system 100, the printing process being controlled according to a plurality of control parameters 108. The printing process is the printing of a print job which comprises one or more objects to be generated. The control parameters 108 specify the manner in which the printing process is performed and is dependent on the additive manufacturing system 100 being used to print the one or more objects of the print process. The processor 106 may for example be a microprocessor, a microcontroller, an application specific integrated circuit, a computer processor or any other processor suitable for the function described herein. In some examples the processor 106 is configured to receive data indicative of a change in operative state of at least one of the energy sources 102a-d the change being detected by the detector 104 during the printing process, one or more remaining layers of an object to be generated not having been processed when the change in operative state is detected. The processor 108 may receive data in the form of unprocessed electrical signals from a detector 104 of the additive manufacturing system 100 and may interpret these signals to determine the change in operative state of the at least one energy source 102a-d. In some examples according to FIG. 1, the processor 106 is configured, in response to receiving said data, to alter at least one of the control parameters 108 to ameliorate a degradation in processing performance caused by the change in operative state. In some examples, the processor 106 is configured to continue the printing process, to process one or more remaining layers of the object to be generated, according to the at least one altered control parameter 108.

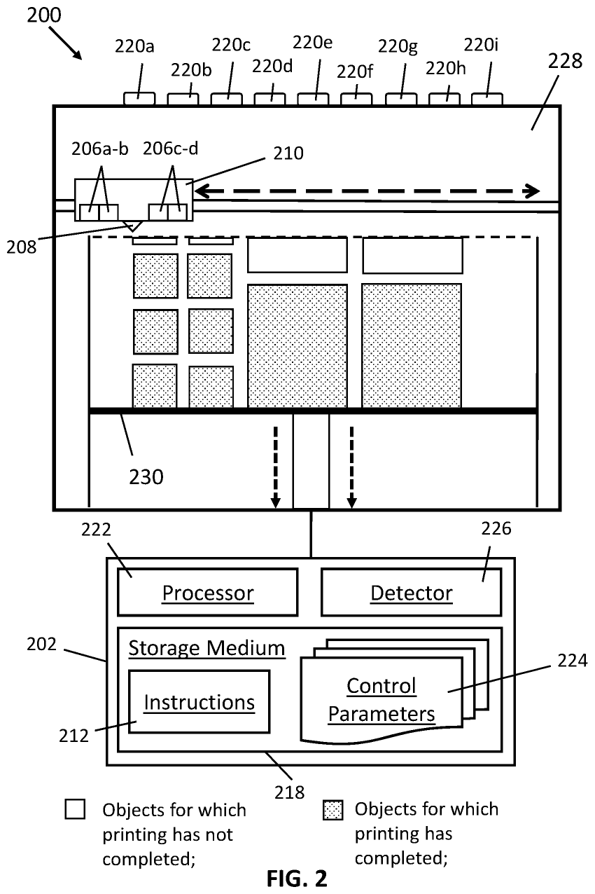

FIG. 2 schematically illustrates a more specific example of an additive manufacturing system 200 than FIG. 1, comprising a plurality of energy sources 220a-i, 206a-d wherein at least one of the energy sources 206a-d is configured to move across a plane which is above and substantially parallel to the layer of material to be processed. The additive manufacturing system 200 according to FIG. 2 comprises a print carriage 210 comprising an agent depositor 208 and a plurality of energy sources 206a-d. The energy sources 206a-d span a full width of the build surface extending into the paper. The print carriage 210 is configured to move over the build surface according to the dotted arrow. As the print carriage 210 moves over the build surface the energy sources 206a-d are configured to heat the build material and the agent depositor 208 is configured to deposit coalescing agent(s) onto the build material. In this example the energy sources 220a-i may be heat sources such as near infra-red lamps. The example of FIG. 2 is shown schematically in two-dimensions. However, FIG. 2 shows schematically a three-dimensional additive manufacturing system 200 in a two-dimensional view. The agent depositor 208 is an array of depositing nozzles, However, in some examples the agent depositor may be a single depositing nozzle capable of depositing coalescing agent in a controllable pattern onto the build material. A nozzle may also be considered a faucet or a spigot. In some examples the coalescing agent is a gel or a paste which can be deposited using a tube. In other examples the agent depositor 208 comprises a printhead such as an inkjet-type print head. In some examples at least one energy source 220a-i, 206a-d is a fuser element for fusing material sequentially in layers. A fusing element may be a specific type of energy source which supplies a suitable amount of energy in a suitable form to a combination of build material and coalescing agent to cause the build material to coalesce and fuse. In other examples at least one energy source may be for curing or hardening build material which has been solidified by the application of a chemical binding agent onto said build material.

The additive manufacturing system of FIG. 2 comprises a supporting member 230 onto which the first layer of build material is deposited at the start of a print process. A supporting member 230 may also be considered a platform, a plate, a stand or any other structure which is suitable for performing the function described herein. The mechanism for depositing the layers of build material onto the build surface is not illustrated so as not to obfuscate FIG. 2. However, in the example of FIG. 2, build material may be deposited from at least one reservoir of build material and a roller may be used to spread the build material over the build surface. In examples according to FIG. 2 the build material is a powdered material suitable for being deposited evenly across a build surface. A powdered material may be considered a wet or a dry powdered material. Powdered material suitable for this application may include powdered polymeric materials, powdered metallic materials, powdered ceramic materials, powdered glass materials, powdered resin materials, any combination of these materials, or any material suitable for the function described herein. In other examples build material may relate to gels, pastes, liquids or other suitable fluidic build materials.

As discussed above build material may be deposited onto the build surface by for example, a roller configured to spread build material at an even thickness across the build surface. The roller may move over the surface of the build material in a perpendicular direction to the motion of the print carriage illustrated by the dotted arrow. However, in other configurations, successive layers of build material may be deposited or distributed to the build surface by at least one nozzle, tube, faucet, spraying device, any other device suitable for distributing the build material over the build surface, or a combination of several such devices. The build material may be deposited unevenly across the surface and then smoothed out or the build material may be directly applied evenly to the build surface. The build material may be deposited by a carriage configured to pass over the build surface. In examples where the build material is deposited by a carriage, the carriage may store the build material for successive layers or the build material may be stored elsewhere and distributed by the carriage.

The carriage 210 of the additive manufacturing system in FIG. 2 moves over the build material allowing the energy sources 206a-d to pre-heat the build material before the agent is deposited on the portions of the build material which are to be fused or solidified. The energy sources 206a-d heat the combination of build material and agent causing the portion of the build material on which coalescing agent is deposited to solidify. The coalescing agent distributed by the agent distributer 208 may be housed in the print carriage 210 or may be stored externally to the print carriage 210. Other agents such as modifying agents, which may be agents configured to modify the properties or severity of a solidification of build material, may be deposited onto the build material and energy may be applied to the build material by the energy sources 206a-d on the carriage. The modifying agents may be applied before or after the coalescing agents are applied to the build material. The example additive manufacturing system 200 of FIG. 2 comprises stationary energy sources 220a-i which are configured to heat the build material before the printer carriage 210 moves over the build material. By heating the build material with the stationary energy sources 220a-i, the amount of energy which needs to be applied by the energy sources 206a-d on the print carriage 210 is reduced.

After a portion of the first layer of the build material is solidified, the supporting member 230 is lowered by an amount substantially equivalent to the depth of the layer. A fresh layer of build material is then applied over the entire previous layer of build material including both solidified and non-solidified portions and the process is repeated. The shape of the objects is determined by the portion of each successive layer of build material on which coalescing agent is applied as the portions on which coalescing agent is applied are the portions of build material which may solidify and form the objects.

The print process performed by the additive manufacturing system 200 of FIG. 2 may be controlled by a controller 202 which comprises a processor 222 and a storage medium 218 which stores control parameters 224, used to control the print process, and instructions 212, used to instruct the processor 222. The controller 202 may have any number or type of user interfaces. For example, the controller 202 may be connectable to an external computer allowing a user to send print job data comprising data indicative of a print process for printing one or more objects. The controller 202 of the additive manufacturing system 200 may have a direct user interface such as any combination of hardware and program code suitable for interfacing a user. For example, the controller 202 of the additive manufacturing system 200 may comprise or be connected to a touch screen configured to receive user input and display data.

The controller of FIG. 2 may comprise a detector 226 for detecting changes in operative state of at least one energy source 220a-i, 206a-d of the additive manufacturing system 200. The processor 222 may be used to begin a print process using received print job data, according to a plurality of control parameters 224. The plurality of control parameters 224 may be modified, updated, or changed before or during a print process. Print job data may comprise a plurality of control parameters 224 specific to said print job. The processor 222 may receive data, indicative of a change in operative state of at least one energy source 220a-i, 206a-d, generated by the detector 226. In response to receiving said data indicative of a change in operative state of the at least one energy source 220a-i, 206a-d the processor 222 may alter, modify, reconfigure, or change at least one of the control parameters 224. The processor 222 may be configured to continue the print process according to the at least one altered control parameter 224.

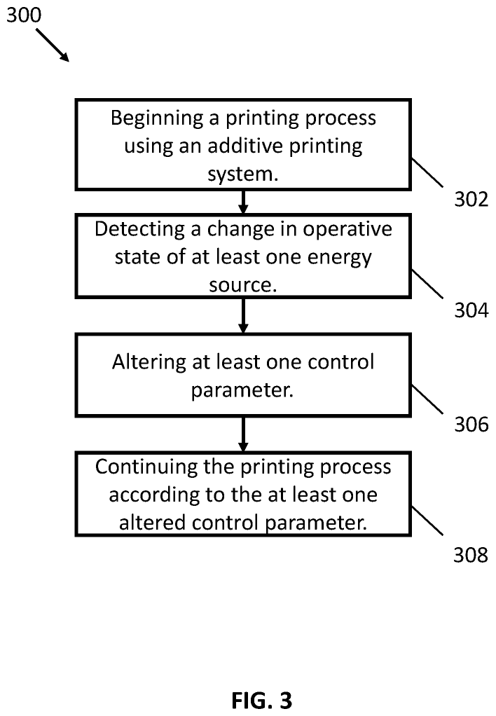

Moving to FIG. 3, a flow chart 300 showing a method of printing one or more objects is shown according to examples. At block 302 the method comprises beginning a printing process using an additive manufacturing system 200 comprising a plurality of energy sources 220a-i, 206a-d for processing material sequentially in layers, the printing process being controlled according to a plurality of control parameters 224. At block 304 the method comprises detecting a change in operative state of at least one of the energy sources 220a-i, 206a-d during the printing process, one or more remaining layers of an object to be generated not having been processed when the change in operative state is detected. In some examples the remaining layers not having been processed include layers for which build material and any number of agents have been deposited but which have not yet had suitable energy supplied to them to cause them to solidify. The remaining layers not having been processed may also include layers for which build material has not yet been deposited. At block 306 the method specifies, in response to the detection, altering at least one of the control parameters 224 to ameliorate a degradation in processing performance caused by the change in operative state. Block 308 of the method, according to the example of FIG. 3, specifies continuing the printing process, to process the one or more remaining layers of the object to be generated, according to the at least one altered control parameter 224.

In some examples where the at least one energy source 220a-i, 206a-d which undergoes a change in operative state is a lamp, and the change in operative state is a burnout of said lamp, it is not possible to replace the lamp during a printing process. In additive manufacturing systems which are unable to modify a control parameter, it may be that once a lamp burns-out, the printing process moves to an annealing or cooling process where the objects which are completed are recovered and incomplete objects are discarded, resulting in a waste of material in the discarded objects.

In some examples the plurality of control parameters 224 comprises an irradiance value for each of the energy sources 220a-i, 206a-d. In some examples of additive manufacturing systems 200, the energy output by the energy 220a-i, 206a-d may be controlled. Different energy sources 220a-i, 206a-d may be used to apply different amounts of energy to the build material using different methods. In some examples, the additive manufacturing system 200 comprises different types of energy sources 220a-i, 206a-d. Some of the energy sources 220a-i, 206a-d may be configured to irradiate more energy than others. For example, energy sources 206a-d which pass over a build surface may be configured to apply more energy than stationary energy sources220a-i positioned at the top of the build chamber. The irradiance of each energy source 220a-i, 206a-d in the additive manufacturing system 200 may be controllable by controlling for example the current which is passed through the energy source. In examples where the plurality of control parameters 224 comprises an irradiance value for each of the energy sources 220a-i, 206a-d it may be possible, following the change in state of at least one of the energy source 220a-i, 206a-d, to modify or alter the irradiance of at least one of the energy sources 220a-i, 206a-d such that the energy delivered to the build material and any number of agents is suitable to facilitate solidification of the build material, or suitable to cure a chemically solidified portion of build material. This may include for example, following the burnout of an energy source 206a-d configured to move on a print carriage 210 over the build surface, increasing the irradiance of at least one energy source 220a-i positioned at the top of the build chamber 228 such that the energy which is applied to the build material by at least one remaining energy sources 206a-d on the carriage 210 is suitable for facilitating the solidification or fusing the build material. In other examples the irradiance of at least one remaining energy source 206a-d on the carriage 210 may be increased to ameliorate the degradation in processing performance caused by the change in operative state of the energy source 206a-d positioned on the print carriage 210. In other examples following a change in operative state of at least one of the stationary energy sources 220a-i positioned at the top of the build chamber 228, the irradiance of at least one energy source 206a-d positioned on the print carriage 210 may be increased to ameliorate the degradation in fusing performance caused by the change in operative state.

In some examples the plurality of control parameters 224 comprises a speed at which at least one of the energy sources 206a-d passes across a plane which is above and substantially parallel to a layer of the material to be processed. The speed at which at least one of the energy sources 206a-d passes over the build surface may determine the amount of energy which is delivered by said energy source 206a-d to the build material. In some examples, during the print process at least one energy source 206a-d which is configured to move over the build surface may be configured to emit a substantially constant amount of energy. If the speed at which the energy source 206a-d configured to emit energy at a substantially constant rate, is moved over a build surface is increased then the energy applied to the build material positioned at the build surface is decreased. The power applied to the build material by a moving energy source 206a-d is related to the squared speed of the movement of the energy source over the build material.

In some examples, in response to the detection of a change in operative state of a stationary energy source 220a-i, the speed at which a carriage 210 which comprises at least on energy source 206a-d is moved over the build surface may be decreased such that more energy is applied to the build material by the energy sources 206a-d positioned on the carriage 210 to ameliorate the degradation in processing performance resultant from the change in operative state of the stationary energy source 220a-i. In other examples, a print carriage 210 may comprise more than one energy source 206a-d and at least one of the energy sources 206a-d of the print carriage 210 may undergo a change in operative state such as a burnout in cases where the at least one energy source is a lamp. In this example it may be possible to ameliorate the degradation in processing performance by reducing the speed of the carriage 210. In other examples a change in operative state may be an uncontrolled increase in irradiance of an energy source, in this case an increase in the speed of the carriage 210 may be used to ameliorate the degradation of the processing performance.

In some examples the plurality of control parameters 224 comprises an indication of a number of times at least one energy source 206a-d passes across a plane which is above and substantially parallel to a layer of the material to be processed. The carriage 210 which may comprise at least one energy source 206a-d may be configured in a printing process to move across the plane above the material to be processed once. For example, in the additive manufacturing system 200 of FIG. 2 a first set of energy sources 206c-d, may be configured to pre heat the build material, the agents may be deposited, and a second set of energy sources 206a-b may be configured to supply suitable energy to the combination of build material and agents to facilitate solidification of the build material. However, the carriage 210 may also be configured to move across the plane above the build material in the opposite direction such that more energy is applied to the build material for the facilitation of solidification of the build material. The total number of times which the print carriage 210, on which energy sources 206a-d may be disposed, moves across the plane above the material to be processed may be a control parameter 224 which is determined based on the total irradiance of the energy sources 206a-d on the print carriage 210 and the build material which is to be processed. A change in operative state of an energy source 220a-i, 206a-d such as a lamp burnout, during a printing process in an additive manufacturing system 200 may be addressed by increasing the number of passes which the print carriage 210 makes over the build material. Increasing the number of passes may result in the total amount of energy supplied to the build material being higher than if the number of passes made by the energy sources 206a-d over the build material was not to be altered. In this case, maintaining the same irradiance of the unchanged energy sources 220a-i, 206a-d may mean that it is insufficient to increase the number of passes which an energy source makes over the build material to ameliorate the degradation in processing performance. However, in some cases and for some print materials it may be possible to increase the number of passes at least one energy source makes over the build material to ameliorate the degradation in processing performance.

As discussed previously, in some examples at least one energy source 206a-d disposed on the print carriage 210 may be configured to preheat the build material before coalescing agents are applied and before energy is applied to facilitate the solidification of the build material on which the agents are applied. In these examples, it may be that a change in operative state of at least one of the energy sources 206a-d configured to pre heat the build material results in less degradation of the processing of material. In these examples, it may be possible to perform a first pass over the build material without depositing coalescing agents such that at least one operating energy source 206a-d disposed on the print carriage 210 can suitably preheat the build material before applying the coalescing agents and applying energy to solidify the build material. Although the above has been a discussion on specific examples where a change in the number of passes a print carriage 210, on which energy sources 206a-d are disposed, makes over the build material is used to ameliorate a degradation in processing performance, it is acknowledged that there are many possibilities for altering the number of times at least one energy source 206a-d passes over a build material to ameliorate a degradation in processing performance. It is also acknowledged that different alterations in the number of passes may be suitable in different instances of a change in operative state.

Build material used to print three-dimensional objects in additive manufacturing 200 systems may be defined by a set of properties. The set of properties may include; a specification of a suitable amount of energy to solidify the build material in the presence of coalescing agent, a specification of an amount of energy suitable to preheat the build material before the deposition of coalescing agents, the time for which a suitable power is applied to the build material to facilitate the solidification of the build material, or the like. Different build materials such as powdered metallic materials may have different properties to other build materials such as powdered polymer materials. Accordingly, in some examples the alteration of the at least one control parameter 224 is dependent on properties of the material of the remaining layers of the object to be generated which have not been processed when the change in operative state is detected. For example, if the remaining layers of an object to be generated are to be printed using powdered metallic materials then the alteration of the control parameters may be different to a case where the remaining layers of the object to be generated are to be printed from powdered polymer materials.

In some examples of additive manufacturing, an object to be generated may be printed from more than type of build material. For example, a first part of an object may be printed from polymeric materials and a second part of an object may be printed from a metallic material. A change in operative state of at least one energy source 220a-i, 206a-d in this example may be detected during the printing of the first part of the object. The control parameters 224 of the print process may be altered in a first instance to ameliorate the degradation in processing performance. As the print progresses the printing of the first part of the object may be completed and the printing of the second part of the object may commence. However, the altered control parameters 224 may be ill suited to control printing of metallic material. The control parameters 224 may be altered in a second instance without detecting a second change in operative state such that the altered control parameters 224 are suitable for ameliorating a degradation in processing of metallic materials following the first detection of the change in operative state of the energy source 220a-i, 206a-d.

In some examples, a combination of control parameter 224 alterations may be made in order to ameliorate a degradation in processing performance following a change in operative state of at least one energy source 220a-i, 206a-d. For example, where energy sources 206a-d disposed on a print carriage configured to preheat build material fail, the preheating of the build material may be performed by increasing the irradiance of at least one stationary energy source 220a-i disposed at the top of the build chamber 228. However, in this case it may be that energy sources 206a-d disposed on the print carriage 210 configured to apply energy to the build material to facilitate the solidification of the build material provide an excessive amount of energy to the build material and damage the build material. In this case it may be possible to combine the increase of energy in a stationary energy source 220a-i with the increase in speed of the carriage 210 or reduction of irradiance of the energy sources 206a-d disposed on the print carriage 210 to allow for a suitable amount of energy to be applied to the build material to facilitate the processing of the build material without damaging it. In other examples where at least one energy source 206a-d disposed on the print carriage 210 of FIG. 2 undergoes a change in operative state (for example, a burnout of a lamp), the speed of the carriage 210 may be altered to compensate. However, if an energy source 206c-d configured to preheat the build material burns out and the speed of the carriage 210 is reduced to allow suitable preheating of the build material, the energy sources 206a-b configured to facilitate the coalescing or solidification of the combination of build material and agents may move at a speed over the build material such that they apply a damaging amount of energy to the build material. In this case a combination of reducing the speed of the carriage 210, decreasing the irradiance of the energy sources 206a-b disposed on the carriage 210 for facilitating solidification of the combination of build material and agents, and an increase in the irradiance of the stationary energy sources 220a-i disposed at the top of the build chamber may be sufficient to ameliorate the degradation in processing of build material in subsequent layers.

The alteration or combination of alterations of the control parameters 224 may depend on the properties of the build material in the remaining layers of the object to be generated which have not been processed when the change in operative state is detected.

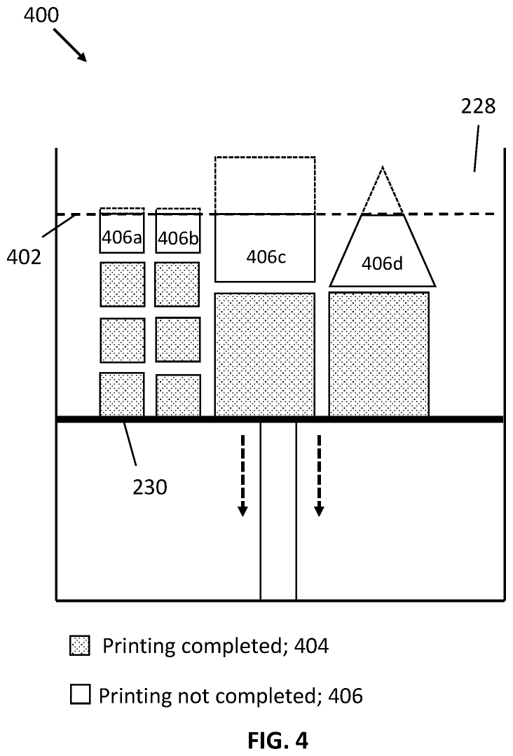

FIG. 4 shows an example of an additive manufacturing system 400, which has begun a printing process, as a change in operative state of at least one energy source is detected. The line 402 shows the position of layer of build material being processed in the build chamber 228 as the change in operative state is detected. There are some objects 404 in the build chamber 228 which are completed and other objects 406a-d which are not completed. In some examples the method may comprise, in response to said detecting the change in operative state, selecting at least one object 406a-d one or more remaining layers of the at least one object not having been processed when the change in operative state is detected, not to be generated. In some examples objects which are to be generated in the print process may be designed to have specific mechanical properties. The degradation of processing performance according to the change in operative state of at least one energy source 220a-i, 206a-d may result in the additive manufacturing system 400 being unable to produce objects with these specific mechanical properties. This may be true even when control parameters 224 are altered to ameliorate the degradation in printing performance due to the change in operative state. In such examples the processor 222 may select the objects 406a which are to be printed with specific mechanical properties, not to be generated. Mechanical properties may be properties such as, tensile strength, flexibility, hardness, or other such properties. The objects which are selected not to be completed in the event of a change in operative state of at least one energy source may be preselected by a user before a print process is started or may be selected based on a desired mechanical property of the object from user input.

In other examples, the at least one object selected not to be generated is selected based how many remaining layers, of the at least one object, have not been processed when the change in operative state is detected. In the examples according to FIG. 4 it is shown that some objects, for example 406a-b, may have few remaining layers to be processed when the change in operative state is detected. In this case, the degradation in processing performance following the change in operative state will affect the few remaining layers which have not been processed. It may be that having a few layers of an object 406a-b which are printed under a degraded processing performance does not inhibit the objects 406a-b from being used for their desired purpose. For example, the unprocessed layers may be the thickness of an outer surface or finish and may not affect the structure or integrity of the entire object 406a-b. Other objects, such as 406c-d may have many remaining layers, In the case where there are many remaining layers to be processed, printing the remaining layers with a degraded processing performance may be dissatisfactory as the structure and integrity of the object 406c-d may be affected.

In some examples the at least one object selected not to be generated is selected based on a predetermined proportion, of a total amount of material suitable for printing all layers of said at least one object, having not been processed when the change in operative state is detected. Selecting objects to be generated based on the number of remaining layers to be processed may not be an efficient way of reducing waste in additive manufacturing systems in all circumstances. For example, for some objects 406d a first portion of the object which is to be printed may use significantly more build material to print than a second portion of the object 406d which is to be printed, wherein the first portion and the second portion of the object comprise a similar number of layers. An example of such an object 406d is shown in FIG. 4. In cases such as this it may be that due to a large proportion of total material for printing the object 406d having already been printed, the object 406d may be selected to be completed. The inverse may be true for other examples. In examples where there are few remaining layers to be processed but the proportion of total build material for printing the object which has been used is low it may be that printing the remaining layers using an additive manufacturing system 200 where a change in operative state of at least one energy source 220a-i, 206a-d is detected may not be ideal. A user might configure the one or more objects to be generated in a print process in relative positions and orientations to alleviate the need to consider this information by causing each successive layer of the objects which are printed to use substantially similar amounts of build material to previous layers.

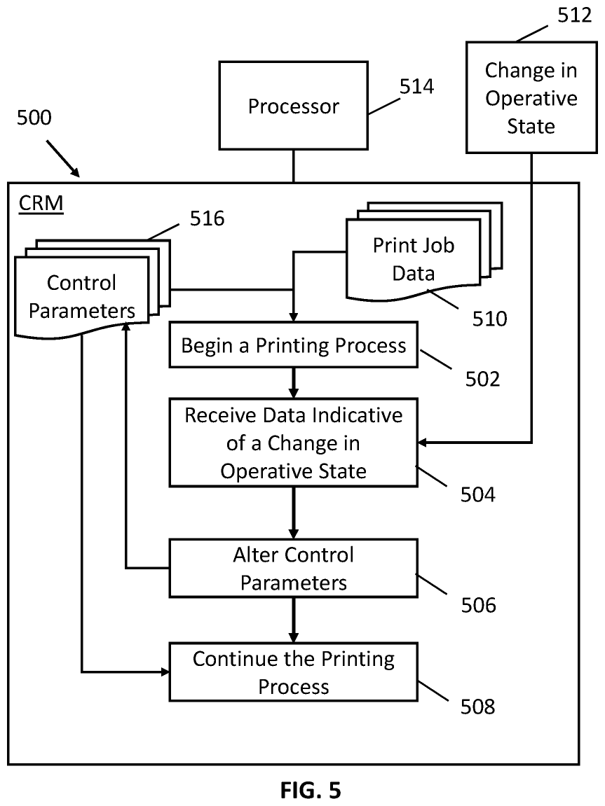

FIG. 5 shows schematically a non-transitory computer readable storage medium 500 storing instructions that, when executed by a processor 514, cause a processor 514 to perform the function described herein. At block 502 the instructions cause the processor 514 to begin a printing process using an additive manufacturing system 200 comprising a plurality of energy sources 220a-i, 206a-d for processing material sequentially in layers, the printing process being controlled according to a plurality of control parameters 516. The processor 514 may receive print job data 510 generated at an external computer or input directly to the additive manufacturing system 200. Print job data 510 provided to the processor 514 for beginning the printing process may comprise an indication of objects to be selected not to be completed in the event of a change in operative state of at least one energy source 220a-i, 206a-d. In some examples the print job data 510 used to begin the printing process of one or more objects may comprise an indication of a limit of the number of layers suitable to be printed with a degraded processing performance following a change in operative state of at least one energy for each object. The additive manufacturing system 200 may comprise any combination of hardware and programming code to modify or alter the received print job data 510. Print job data 510 may comprise object data specifying the properties, shape, size, number of layers, a position in the build chamber 228 during a print process, or any other information which may be used by the processor 514 to begin a print job. As discussed above the control parameters 516 may comprise a number of passes which at least one energy source 206a-d makes over a build surface, the irradiance of at least one energy source 220a-i, 206a-d the speed which at least one energy 206a-d is moved over the build surface, or any other value or variable which may be used to control a print process. The processor 514 may be configured to send electrical signals to at least one energy source 220a-i, 206a-d. The processor 514 may be configured to control any number of servos, motors, pumps, or other electro-mechanical systems for operating an additive printing system to print one or more objects. The control parameters 516 may be stored as an array in memory which may be accessed by the processor 514 for providing signals to the devices of the additive printing system 200 which the processor is configured to control. The control parameters 516 may be stored on the computer-readable storage medium 500 or they may be stored externally from the computer readable storage medium on for example, a second storage medium.

A storage medium may be a non-transitory computer-readable storage medium for example, a hard drive, a CD-ROM disc, a USB-drive, a solid-state drive or any other form of magnetic storage device, optical storage device, or flash memory device, maintained locally or accessed remotely, capable of having thereon computer readable code suitable for the function described herein.

Block 504 of FIG. 5 specifies that the instructions, when executed by the processor 514 may cause the processor 514 to receive data indicative of a change in operative state 512 of at least one of the energy sources 220a-i, 206a-d during the printing process, one or more remaining layers of an object to be generated not having been processed when the data is received. The data indicative of the change in operative state may comprise an indication of how the operative state of the at least one energy source 220a-i, 206a-d has changed and from which energy source 220a-i, 206a-d the data indicative of the change in operative state is generated.

At block 506 the instructions cause the processor 514 to, in response to receiving said data, alter at least one of the control parameters 516 to ameliorate a degradation in processing performance caused by the change in operative state. At block 508 the instructions cause the processor 514 to continue the printing process, to process the one or more remaining layers of the object to be generated, according to the at least one altered control parameter 516. In some examples the said altering of the at least one control parameter 108 is dependent on with which energy source 220a-i, 206a-d the data indicative of the change in operative state is associated. For example, in additive manufacturing systems 200 comprising both stationary energy sources 220a-i and energy sources 206a-d configured to move over a build surface to apply energy to a build material, a degradation of processing performance caused by a change in operative state of a stationary energy source 220a-i may be ameliorated by altering a first control parameter, or a first combination of control parameters. Whereas a degradation of processing performance caused by a change in operative state of an energy source 206a-d configured to move over the build surface may be ameliorated by altering a second control parameter, or a second combination of control parameters, wherein, the second control parameter, or second combination of control parameters is different to the first in each case. Alternatively, the first control parameter or the first combination of control parameters may be altered in a different way to the alteration performed following a change in operative state of the stationary energy source 220a-i.

As discussed in examples above more than one control parameter 516 may be altered. In some examples the said altering of the at least one control parameter 516 comprises altering a number of passes, which at least one energy source 206a-d makes across the plane which is above and substantially parallel to a layer of the material to be processed, and the speed of each pass. For example, the movement of energy sources 206a-d configured to pass over the build surface may be altered such that the energy sources 206a-d may pass over the build surface more than once and each pass may proceed at a different speed. A first pass may be performed at a first speed suitable for preheating the build material and a second pass may be performed at a second speed suitable for processing the material. The alteration may change the number of passes and the speed of each pass.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of generating one or more objects, comprising:
beginning a printing process, using an additive manufacturing system comprising a plurality of energy sources for processing material sequentially in layers, the printing process being controlled according to a plurality of control parameters;
detecting a change in operative state of at least one of the energy sources during the printing process, one or more remaining layers of an object to be generated not having been processed when the change in operative state is detected;
in response to the detection, altering at least one of the control parameters to ameliorate a degradation in processing performance caused by the change in operative state; and
continuing the printing process, to process the one or more remaining layers of the object to be generated, according to the at least one altered control parameter.

2. A method according to claim 1, wherein the plurality of control parameters comprises an irradiance value for each of the energy sources.

3. A method according to claim 1, wherein the plurality of control parameters comprises a speed at which at least one of the energy sources passes across a plane which is above and substantially parallel to a layer of material to be processed.

4. A method according to claim 1, wherein the plurality of control parameters comprises an indication of a number of times at least one energy source passes across the plane which is above and substantially parallel to the layer of material to be processed.

5. A method according to claim 1, wherein the alteration of the at least one control parameter is dependent on properties of the material of the remaining layers of the object to be generated which have not been processed when the change in operative state is detected.

6. A method according to claim 1, comprising, in response to said detecting the change in operative state, selecting at least one object having one or more remaining layers that have not been processed, not to be generated.

7. A method according to claim 6, wherein the at least one object selected not to be generated is selected based how many remaining layers, of the at least one object, have not been processed when the change in operative state is detected.

8. A method according to claim 6, wherein the at least one object selected not to be generated is selected based on a predetermined proportion, of a total amount of material for printing all layers of said at least one object, having not been processed when the change in operative state is detected.

9. An additive manufacturing system for generating one or more objects comprising:
a plurality of energy sources for processing material sequentially in layers;
a detector to detect a change in operative state of at least one of the energy sources during a printing process; and
a processor configured to:
begin a printing process using an additive manufacturing system, the printing process being controlled according to a plurality of control parameters;
receive data indicative of a change in operative state of at least one of the energy sources the change being detected by the detector during the printing process, one or more remaining layers of an object to be generated not having been processed when the change in operative state is detected;
in response to receiving said data, alter at least one of the control parameters to reduce the effect of a degradation in processing performance caused by the change in operative state; and
continue the printing process, to process the one or more remaining layers of the object to be generated, according to the at least one altered control parameter.

10. An additive manufacturing system according to claim 9, wherein the at least one energy source is a fuser element for fusing material sequentially in layers.

11. An additive manufacturing system according to claim 9, wherein at least one of the energy sources is configured to move across a plane which is above and substantially parallel to a layer of material to be processed.

12. An additive manufacturing system according to claim 9, wherein the data indicative of a change in operative state comprises information indicative of from which energy source the change in operative state is detected.

13. A non-transitory computer readable storage medium storing instructions that, when executed by a processor, cause a processor to:
begin a printing process using an additive manufacturing system comprising a plurality of energy sources for processing material sequentially in layers, the printing process being controlled according to a plurality of control parameters;
receive data indicative of a change in operative state of at least one of the energy sources during the printing process, one or more remaining layers of an object to be generated not having been processed when the data is received;
in response to receiving said data, alter at least one of the control parameters to ameliorate a degradation in processing performance caused by the change in operative state; and
continue the printing process, to process the one or more remaining layers of the object to be generated, according to the at least one altered control parameter.

14. A storage medium according to claim 13, wherein the said altering of the at least one control parameter is dependent on with which energy source the data indicative of the change in operative state is associated.

15. A storage medium according to claim 13, wherein the said altering of the at least one control parameter comprises altering a number of passes, which at least one energy source makes across the plane which is above and substantially parallel to a layer of the material to be processed, and the speed of each pass.
